(19) United States
(12) Patent Application Publication
(10) Pub. No.: US 2026/0361164 A1
(43) Pub. Date: Nov. 12, 2026

(54) BAND FOR AN ELECTRIC MACHINE IN A MULTI-PART EMBODIMENT, MAGNET CARRIER WITH A BAND, ROTOR AND AXIAL FLUX MOTOR

(71) Applicant: Schaeffler Technologies AG & Co. KG, Herzogenaurach (DE)

(72) Inventors: Carsten SONNTAG, Gauting-Konigswiesen (DE); Daniel Mahler, Hofstetten (DE); Johann Oswald, Eschenlohe (DE)

(73) Assignee: Schaeffler Technologies AG & Co. KG, Herzogenaurach (DE)

(21) Appl. No.: 19/139,929

(22) PCT Filed: Oct. 19, 2023
(86) PCT No.: PCT/DE2023/100780

§ 371 Date: Jun. 17, 2026

(30) Foreign Application Priority Data
Dec. 19, 2022 (DE) 10 2022 133 940.8

(51) Int. Cl. H02K 1/28; H02K 1/2795

(52) U.S. Cl. CPC H02K 1/28; H02K 1/2795

(57) ABSTRACT

A magnet carrier for a rotor of an axial flux motor, comprising a main body which is designed to receive a plurality of magnets in a magnet-receiving region, wherein the main body is in the form of a plastic body with reinforcing fibres, wherein the main body is connected to a band insert, separate from the main body, radially outside the magnet-receiving region, but spaced apart from the outer edge of the main body. The disclosure also relates to a rotor for an axial flux motor with a magnet carrier according to the disclosure, as well as an axial flux motor with the rotor according to the disclosure.

### CROSS-REFERENCE TO RELATED APPLICATIONS

This application is the U.S. National Phase of PCT Appln. No. PCT/DE 2023/100780, filed Oct. 19, 2023, which claims the benefit of German Patent Appln. No. 102022133940.8, filed Dec. 19, 2022, the entire disclosures of which are incorporated by reference herein.

### TECHNICAL FIELD

The disclosure relates to a magnet carrier for a rotor of an axial flux machine, comprising a main body which is prepared to receive a plurality of magnets in a magnet-receiving region, wherein the main body is designed as a plastic body having reinforcing fibers. The disclosure also relates to a rotor for an axial flux motor comprising a magnet carrier according to the disclosure and an axial flux machine comprising the rotor according to the disclosure.

### BACKGROUND

A rotor of an electric rotary machine and an electric rotary machine equipped therewith are known from the prior art, for example from WO 2022/073533 A1. The rotor of the electric rotary machine comprises a plurality of magnets and a magnet carrier for fixing the magnets, with which carrier the magnets are positioned on a periphery with respect to a hub of the rotor, wherein the magnet carrier extends radially outwards further than the magnets and has a first axial width at the periphery of the positioning of the magnets and forms a widened portion radially outside the magnets which has a second axial width which is greater than the first axial width.

### SUMMARY

It is the object of the present disclosure to provide an improved magnet carrier in order to reduce the disadvantages of the known solutions, in particular to increase the rigidity of the magnet carrier and/or the rotor in the axial direction.

This object is achieved in a generic magnet carrier according to the disclosure, in that the main body is connected to a band insert/band/retainer, separate from the main body, radially outside the magnet-receiving region, but spaced apart from the outer edge of the main body.

In other words, the disclosure relates to the rotor of an electric machine, in particular an axial flux machine. This type of machine is known from various applications and has a number of special features and advantages when used as a traction machine for a vehicle, for example. There are various basic versions or designs of the axial flux machine, which differ in terms of the variable arrangement of the rotor and/or stator. The disclosure described below relates to the I arrangement and the H arrangement. The I arrangement is defined by an internal rotor and the H arrangement by two external rotors. Various combinations of both arrangements with even more rotors and stators also exist. In principle, the disclosure described can technically be used for all arrangements, preferably for high-speed, large-diameter machines in a compact installation space.

The magnet carrier already known in WO 2022/073533 A1, also known as a band, can also protrude in the axial direction in places, thereby partially, completely or further overlapping the mechanical air gap of the arrangement.

In addition, the rigidity of the band/magnet carrier has an effect on its stability and/or the state of stress at the speed of the entire disc. Band materials used for obtaining a high degree of rigidity are high-modulus (HM-CFRP fiber) or ultra-high-modulus (UHM-CFRP fiber) carbon fibers, which are wound endlessly around the rotor in a matrix or pressed on as a prefabricated or partially prefabricated component.

In the solution presented here to improve the stability/rigidity of the carrier material, a separate band insert is inserted radially outside the magnet-receiving region but spaced apart from the outer edge of the magnet carrier. This provides numerous advantages. Under suitable loads, these materials have above-average fatigue strength and a very high supportable number of load cycles compared to other composite materials or metals. The notch sensitivity of the magnet carrier/band can be reduced by inserting a band insert made of a HM-CFRP fiber or a UHM-CFRP fiber. Furthermore, rigidity variations or variations in the load on the wound magnets, the surrounding structure and the magnet carrier can be reduced or eliminated. Local effects that occur in the case of high speeds and large diameters, i.e., at high power densities, are reduced. The naturally-occurring relatively low rigidity of a disc in the axial direction, i.e. when gyroscopic forces are applied, can counteract deformation of the disc. By reducing or eliminating deformations of the disc, the required gap dimensions can be reduced, thus increasing the power density and efficiency of the axial flux machine.

The inventive solution to the problem is therefore to improve the rigidity of the magnet carrier, and thus of the entire rotor.

For this purpose, a magnet carrier for a rotor of an axial flux machine is connected to a main body, which is prepared to receive a plurality of magnets in a magnet-receiving region, comprising a band insert. The main body is designed as a plastic body having reinforcing fibers. The band insert is designed as a separate component and is connected to the main body radially outside the magnet-receiving region but spaced apart from the outer edge of the main body.

The magnet carrier is therefore made from two separate components, which have different properties.

Advantageous embodiments are claimed in the dependent claims and are explained in more detail below.

Advantageously, the main body is made of a different material than the band insert, so that the different material properties lead to different interactions. For example, the rigidity of the material and thus the rotor can be improved if one of the two materials used has a higher rigidity than the other. This means that different properties of the magnet carrier can be achieved with different material properties.

The band insert is preferably provided in such a way that it has a higher transverse load capacity and/or a higher tensile strength and/or a higher elongation at break than an edge section extending from the magnet-receiving region to the outer edge of the main body. This results in improved load transfer to the main body and the edge section of the main body. This is intended to attenuate local stress peaks and thus even out the load transfer and create a good surface for the main body. The rigidity of the material used is of secondary importance. Only the longitudinal elongation at break of the material used is of significant importance. The longitudinal elongation at break at approximately 55% fiber volume content is at or above 1%.

The edge section for compensating the centrifugal forces, in particular the centrifugal force, preferably has a higher rigidity and/or higher strength than the band insert. This reduces the deformability of the magnet carrier/band in the radial direction, so that the magnet carrier has a high degree of strength even in the case of high speeds and large radii and the efficiency of the axial flux machine is ensured.

The edge section preferably has a T-shaped or rectangular cross-section. In the case of the edge section having a T-shaped cross-section, the magnet carrier receives an increased area moment of inertia on the radial outer side. This counteracts deformations resulting from the centrifugal forces acting on the rotor. This means that the magnet carrier is stiffened on its radial outer side by a T-shaped design. This has the advantage that the technical air gap between the rotor and stator can be reduced, i.e., a higher power density can be achieved.

In an advantageous embodiment, the magnet-receiving region is defined by the main body which is formed there with two walls.

Advantageously, the main body and/or the band insert is made of an epoxy resin, phenolic, polyester or vinyl resin matrix interspersed with glass and/or carbon fiber. A carbon fiber is preferred which achieves a rigidity in the range of 250 GPa to 400 MPa, particularly preferably 350 MPa, and longitudinal tensile strengths in the range of 700 MPa to 1200 MPa, particularly 1130 MPa in longitudinal tensile strength and 800 MPa in split-disc strength. Due to its properties, the longitudinal elongation at break is less than 1%.

The band insert preferably has a maximum height of 50% of the height of the magnet carrier in the radial direction.

The disclosure also relates to a rotor for an axial flux machine comprising a magnet carrier according to the disclosure.

The disclosure also relates to an axial flux machine comprising a rotor according to the disclosure, which interacts with a stator during operation. Due to the design of the magnet carrier and the rotor, the air gap between the rotor and stator can be reduced in order to improve the efficiency of the axial flux machine. This results in a high power density of the axial flux machine.

The disclosure is also explained in more detail below with the aid of a drawing.

### BRIEF DESCRIPTION OF THE DRAWINGS

In the drawings:

FIG. 1 shows a rotor comprising a first embodiment of a magnet carrier according to the disclosure in a sectional view, and

FIG. 2 shows a cross-section through the magnet carrier of FIG. 1 along line 2.

The figures are only schematic in nature and serve only for understanding of the disclosure. Identical elements are provided with the same reference signs.

### DETAILED DESCRIPTION

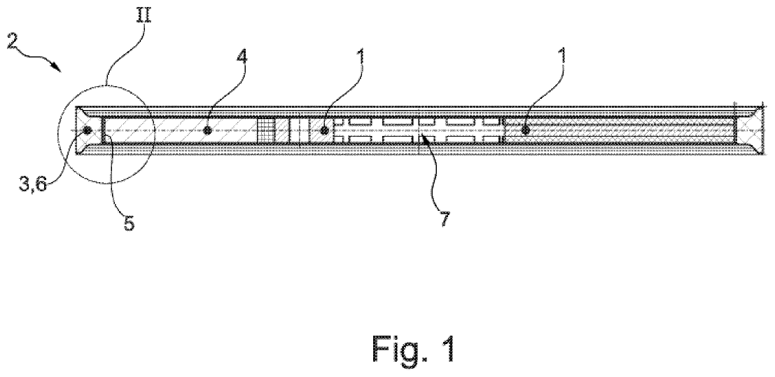

FIG. 1 shows a rotor 2 according to the disclosure, comprising a magnet carrier 1 according to the disclosure in a cross-sectional view. The rotor 2 is known to be a rotor 2 of an axial flux machine in an I arrangement and is therefore designed as a round disc. The magnet carrier 1 has an axis of rotation 7 and extends in a radial direction perpendicular to the axis of rotation 7. The magnet carrier 1 has recesses in which magnets 4 are arranged. A band insert 5 is arranged radially outwardly limiting the magnets 4. The band insert 5 is connected to an edge section 6 of a main body 3 in its radially outer region. The edge section 6 of the main body 3 is T-shaped or has a T-shaped cross-section, which increases the rigidity of the magnet carrier 1. The T-shaped design of the edge region 6 of the main body 3 is such that the edge region 6 has a greater axial width on its radially outer edge and a smaller axial width on its side facing/connected to the band insert 5.

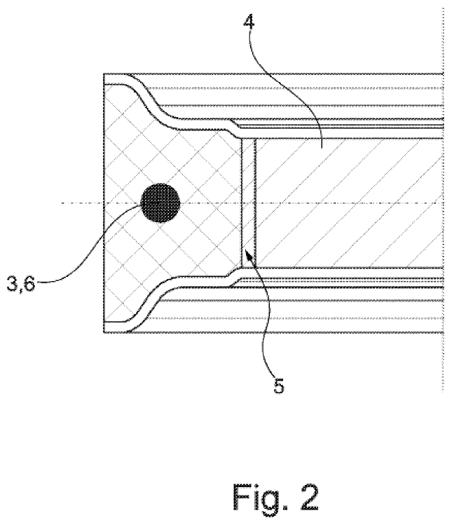

FIG. 2 shows a detailed view at a section line 2 of the sectional view of the rotor 2. The detailed view shows that the main body 3, or the edge region 6 of the main body 3, is made of a different material than the band insert 5. The band insert 5 can be used as a manufacturing aid for the winding process.

### LIST OF REFERENCE SYMBOLS

1 Magnet carrier
2 Rotor
3 Main body
4 Magnet
5 Band insert
6 Edge section
7 Axis of rotation

1. A magnet carrier for a rotor of an axial flux machine, comprising:
a main body configured to receive a plurality of magnets in a magnet-receiving region,
wherein the main body is designed as a plastic body having reinforcing fibers, and
wherein the main body is connected to a band insert,
separate from the main body, radially outside a magnet-receiving region, and spaced apart from an outer edge of the main body.

2. The magnet carrier according to claim 1, wherein the band insert is made of a different material than the main body.

3. The magnet carrier according to claim 1, wherein the band insert has at least one of a higher transverse load capacity or a higher tensile strength or a higher elongation at break than an edge section extending from the magnet-receiving region to the outer edge of the main body.

4. The magnet carrier according to claim 3, wherein the edge section has at least one of a higher rigidity or higher strength than the band insert.

5. The magnet carrier according to claim 4, wherein the edge section has a T-shaped or rectangular cross-section.

6. The magnet carrier according to claim 1, wherein the magnet-receiving region is defined at least in part by two walls of the main body.

7. The magnet carrier according to claim 1, wherein at least one of the main body or the band insert is made of at least one of an epoxy resin, phenolic, polyester or vinyl resin matrix interspersed with glass or carbon fiber.

8. The magnet carrier according to claim 1, wherein the band insert has a maximum of 50% of the height of the magnet carrier in a radial direction.

9. A rotor for an axial flux machine, comprising a magnet carrier according to claim 1.

10. An axial flux machine comprising:
a rotor which interacts with a stator during operation, the rotor including a magnet carrier;
wherein the magnet carrier includes:
a main body configured to receive a plurality of magnets in a magnet-receiving region,
wherein the main body is designed as a plastic body having reinforcing fibers, and
wherein the main body is connected to a band insert,
separate from the main body, radially outside a magnet-receiving region, and spaced apart from an outer edge of the main body.

11. The axial flux machine according to claim 10, wherein the band insert is made of a different material than the main body.

12. The axial flux machine according to claim 10, wherein the band insert has at least one of a higher transverse load capacity or a higher tensile strength or a higher elongation at break than an edge section extending from the magnet-receiving region to the outer edge of the main body.

13. The axial flux machine according to claim 12, wherein the edge section has at least one of a higher rigidity or higher strength than the band insert.

14. The axial flux machine according to claim 13, wherein the edge section has a T-shaped or rectangular cross-section.

15. The axial flux machine according to claim 10, wherein the magnet-receiving region is defined at least in part by two walls of the main body.

16. The axial flux machine according to claim 10, wherein at least one of the main body or the band insert is made of at least one of an epoxy resin, phenolic, polyester or vinyl resin matrix interspersed with glass or carbon fiber.

17. The axial flux machine according to claim 10, wherein the band insert has a maximum of 50% of the height of the magnet carrier in a radial direction.
